(19) United States
(12) Patent Application Publication
(10) Pub. No.: US 2005/0155287 A1
(43) Pub. Date: Jul. 21, 2005

(54) CONTAINER SYSTEM FOR GROWING PLANTS

(76) Inventor: Steven Craig Phillips, Tampa, FL (US)

Correspondence Address: BRIAN D. BELLAMY, P.O. BOX 1997, THOMASVILLE, GA, 31799-1997, US

(21) Appl. No.: 10/905,672

(22) Filed: Jan. 15, 2005

Related U.S. Application Data
(60) Provisional application No. 60/536,575, filed on Jan. 15, 2004.

(51) Int. Cl. A01G 9/02

(52) U.S. Cl. 47/66.1; 47/86; 47/32.7

(57) ABSTRACT

A panelized container system has a plurality of modular panels that are rigid and incapable of significant flexing. The modular panels assemble into a polygonal container for holding soil and growing plants through a plurality of openings in the panels. The panels connect by a union of female and male connecting members. Elongate connecting rods having trapezoid shaped appendages of 45-degree, 90-degree, 180-degree or combined orientation join elongate trapezoid shaped channels formed along the vertical edges of the panels. A selection of panels and connecting rods may be combined into a kit, which may include a tray.

### DOMESTIC PRIORITY CLAIM

The priority of U.S. Provisional Application No. 60/536,575, filed Jan. 15, 2004 is claimed.

### BACKGROUND OF THE INVENTION

1. Field of the Invention

This invention relates to planters for growing plants in a growing medium. In particular the invention relates to a panelized container system for constructing planters for growing multiple plants in a high density. The container system provides for the assembly of planters that are modular, expandable and reconfigurable.

2. Background of the Invention

Containers in which a number of plants can be grown at one time in a growing medium are known. These containers generally consist of small plastic containers or small clay pots having pouches or partitions for placing multiple plants. However, these containers are not modular. A need exists for a modular container that is easy to deliver or store and easily assembled for use.

A disadvantage of many known containers is that they are of fixed sizes, or are at least not readily extended. These prior containers are often not suitable for commercial growing practices, which require high-density growth practices or coverage of wide expanses of area for growing. In particular, prior containers are not configured for expansion by stacking or modular connection for horizontal expansion. Thus, a need also exists for a container that is low cost to construct, high strength, durable, and adaptable to whatever horizontal or vertical configuration is required.

U.S. Pat. No. 4,920,695 to Jeffrey S. S. Garden discloses a container system for growing plants comprising one or more flat but flexible wall panels and connectors for joining adjacent wall panel edges to form a continuous container wall. The panels have openings through which plants can be grown. Integral flaps close openings not in use. Long panel connectors include channels for receiving and engaging complementary panel edges and stiffening the containers. Perforated irrigation tubes may stand in the assembled containers and pass through apertures in top caps. Bottom caps provide drainage. The containers can be extended in size by connecting further wall panels, and some can be stacked. The panel connector means comprises an elongate connector member of a length substantially equal to the lengths of the panel edges to be joined. Garden teaches the elongate connector member having two channels for receiving and engaging two panel edges. Each panel in Garden has four grooves that engage complementary beads on the connector channels when the panel edges are pushed into the channels. The beads engage the grooves and hold the panel edges securely in the connector channel.

It is believed the present invention improves upon the subject matter of the '695 patent to Garden by providing a modular planter system of more durable construction, has a greater number of configuration options, and is more suitable for a variety of commercial agricultural or personal household planting and growing needs.

### SUMMARY OF THE INVENTION

The present invention provides a container system for deployment as a planter that may be configured in rectangular, triangular or trapezoidal configurations. The assembled planter may be used in both residential and commercial settings. The planter includes a plurality of modular panels that are interlocked to form a planter unit, and the panels include a plurality of openings through which plants may grow. When formed into a planter container, the openings may exist along each side of the container or selected sides.

Several planter units may be interlocked to expand the overall area of the planter. The modular characteristics of the planter and ability to expand the size of the planter horizontally and vertically to indefinite dimensions enable the planter for commercial use in unique manners. As a result, the container system may provide increased productivity without increased costs of land. As an additional advantage, the assembled planter can be used with organic growing medium and maintain the organic medium within the confinements of the container to optimize growing conditions and reduce waste or contamination.

The modular panels of the container system form a basic planter unit by interlocking horizontally in a desired configuration. The vertical edges of the panels include connecting means for joining the vertical edges of the panels. A selected number of the panels are joined edge to edge to form an enclosed planter container. One mean for connecting the adjacent panel edges comprises separate elongate female and male connector members of a length substantially equal to the lengths of the panel edges to be joined. Each panel includes a female connecting channel on each vertical edge. The male connecting member provides an elongate rod formed such that an appending portion of the rod inserts into a pair of female connecting channel on opposing panels to join the panels together.

The preferred channel is trapezoid shaped to securely hold the male connecting rod that is inserted therein when joining the panels. Several male connecting rods may be supplied with a modular container system kit for connection of panels at various angles with relation to one another; rods for connecting panels at a 45 degree angle, 90 degree angle, 180 degree angle, or combination of two panels at a 180 degree angle and a third panel at a 90 degree angle to the first two connected panels, such that the three connected panels form a T. The connecting rods include a central portion that supports at least two connecting appendages that extend from the central portion. The appendages comprise trapezoidal shaped members that fit and slide into the trapezoid shaped channels of the female connecting members.

The rigid rectangular construction of the panel members promotes the interconnecting of the panels into expansive configurations for potential commercial agricultural applications. If preferred, the three-dimensional area provided by the exterior panels forming the enclosed planter may be partitioned with interior panels. Further, the assembled planter may be stacked with additional adjoining panels to provide increased vertical volume of growing medium and vertical surface area for planting.

The assembled panels may form a simple rectangular planter unit suitable for home use, and the assembled planter is rigid and, as a simple rectangular unit, is adaptable to being placed on a cart having wheels. Thereby, a person may move the planter from location to location as desired. The cart may include a tray thereupon or incorporated into the cart for holding water or directing excess water to a reservoir or drain. With options for using a water tray and the advantages of rigid construction, the planter does not require the use of plastic liners or the like for holding soil and controlling water retention.

### BRIEF DESCRIPTION OF THE DRAWINGS

FIG. 1 is a side perspective view of a unit of four interlocked panels to form a rectangular planter unit for resting in the tray unit shown.

FIG. 2A is a front planar view of a wall panel for a first embodiment of modular planter.

FIG. 2B is a top view of a panel constructed in accordance with the embodiment disclosed in FIG. 2A.

FIG. 2C is a bottom view of a panel constructed in accordance with the embodiment disclosed in FIG. 2A.

FIG. 2D is a first side edge view of the edge containing the female connecting members of a panel constructed in accordance with the embodiment disclosed in FIG. 2A.

FIG. 2E is a second side edge view of the edge containing the male connecting member of a panel constructed in accordance with the embodiment disclosed in FIG. 2A.

FIG. 3 is an enlarged section view of a female connecting member as shown on the edge containing female connecting members in the panel illustrated in FIG. 2A.

FIG. 4A is a perspective view of a wall panel constructed in accordance with another alternative embodiment of the modular planter.

FIG. 4B is an enlarged partial perspective view of a top corner of the wall panel of FIG. 4A, which further illustrates the channel portion on each edge of the modular wall panel.

FIG. 5A is an end perspective view of a forty-five degree (45°) connecting member constructed for use with the embodiment of the wall panel in FIG. 4A.

FIG. 5B is an end perspective view of a ninety degree (90°) connecting member constructed for use with the embodiment of the wall panel in FIG. 4A.

FIG. 5C is an end perspective view of a one-hundred eighty degree (180°) connecting member constructed for use with the embodiment of the wall panel in FIG. 4A.

FIG. 5D is an end perspective view of a combination ninety degree (90°) and one-hundred eighty degree (180°) connecting member constructed for use with the embodiment of the wall panel in FIG. 4A.

FIG. 6 is perspective cutaway view of a unit of interlocked wall panels to form a rectangular planter unit having two inner panel walls intermediately situated within the larger rectangular planter area, and which further illustrates a cutaway view of soil and plant growth in a portion of the planter.

FIG. 7 is a top perspective view of a tray unit for resting a square four-panel planter unit.

### DETAILED DESCRIPTION OF THE INVENTION

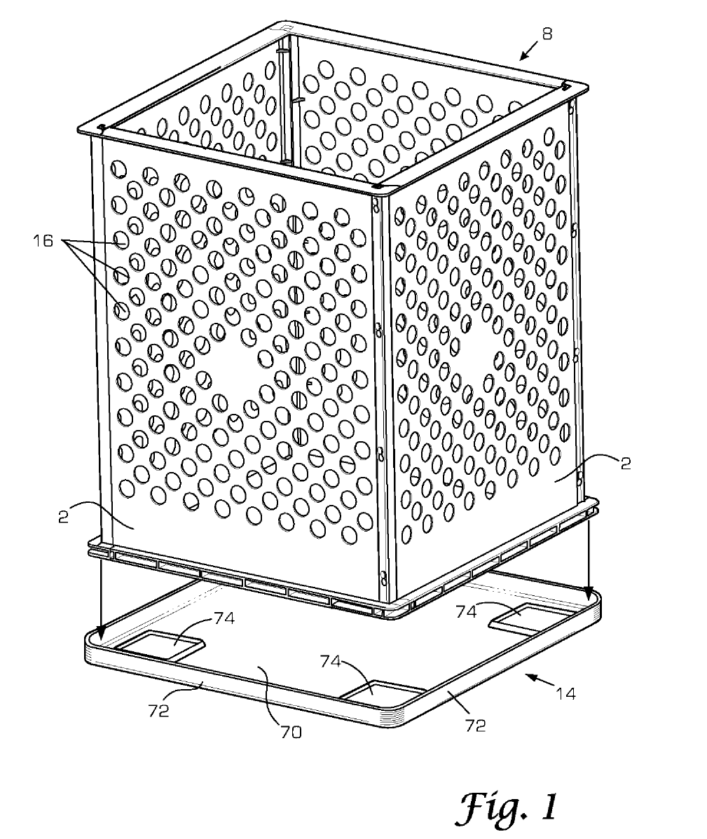

Referring now to the FIGS. 1-7, the present invention comprises a plurality of modular panels 2 in combination with a plurality of connectors for joining the panels adjacently along the vertical edges 4 to form a continuous container wall defining a planting container 6. The container is filled with soil 10 or other growing medium, and plants 12 or seeds are situated in the growing medium and provided appropriate nutrition for growth. As the plants grow, the stems of the plants extend through the container walls to support the leaves of the plant on the exterior of the container. The three-dimensional area of the container extends by several times the growing capacity of the horizontal ground surface area covered by the container by permitting planting along the vertical surfaces of the container. Plants may be planted on top of the container to further extend the growing surface area.

FIG. 1 illustrates a cubical container 8 assembled of four panels 2 of a container system in accordance with an embodiment of the invention. The container system will comprise at least three rigid wall panels per unit assembled. Using the rigid wall panels, a planter unit may be configured into a simple rectangular cube or into larger configurations for either commercial or non-commercial use. The unit in FIG. 1 is configured in a rectangular or square single planter arrangement that may rest in a tray 14. Configuration of the modular panels into a rectangular cube is especially useful for non-commercial purposes such as a patio planter or starter kit.

In one embodiment of the invention, a combination planter construction kit includes a selection of four panels 2, a tray 14, and a minimum of four connecting rods 38 described hereinafter. Additions to the kit may include additional panels and connectors. Thus, an advantage of the invention is the ability to add connectors and panels to the container system for reconfiguring or creating larger planters 8.

The physical composition and construction of the panels 2 provide unique durability and expandability. The preferred panels are constructed of plastic, such as high-density polyethylene, HDPE. The material of construction may be enhanced using ultraviolet radiation inhibitors to improve durability and retention of physical characteristics such as color and surface texture.

The wall panels 2 are stiff and not capable of any significant flexing. In particular, the wall panels cannot be flexed to form a curved configuration. On the contrary, the panel members provide rigid and flat planar wall surfaces when assembled into a polygonal planter 8. As opposed to planters comprising more flexible and fragile material construction, the present rigid and modular panel construction promotes interconnecting of planter units into preferred arrangements.

The FIG. 1 assembly represents a planter 8 constructed in accordance with the modular system of the invention, which is especially suitable for use as a residential strawberry planter. Various arrangements or sizes may be provided using the system; nonetheless a representative strawberry planter is about 36 inches in height, 24 inches in length, and 12 inches wide. The panels 2 comprising the sidewalls are about 0.25 inches thick. The floor panel or tray 14 for retaining the bottom of the container is about 0.375 inches thick; the floor panel is slightly thicker and heavier to prevent damage from the weight of growing medium 10 or water and to provide a sturdy support surface. The overall unit of FIG. 1 may weight about 25 pounds upon construction.

Each panel member 2 may include a plurality of openings 16 through which plants 12 may grow. When the panels are formed into a container 8, the openings may exist along each side of the container. The openings may be distributed over the entire surface area of the panels at a variety of heights and spacing, and the openings may be arranged in horizontal or vertical patterns according to preference. In the embodiment shown, the hole size of the openings is about one inch, which provides for about 480 holes in a cubical planter assembled as shown in FIG. 1 and having dimensions as described hereinbefore. Nonetheless, the hole size may be varied according to plant size and density desired.

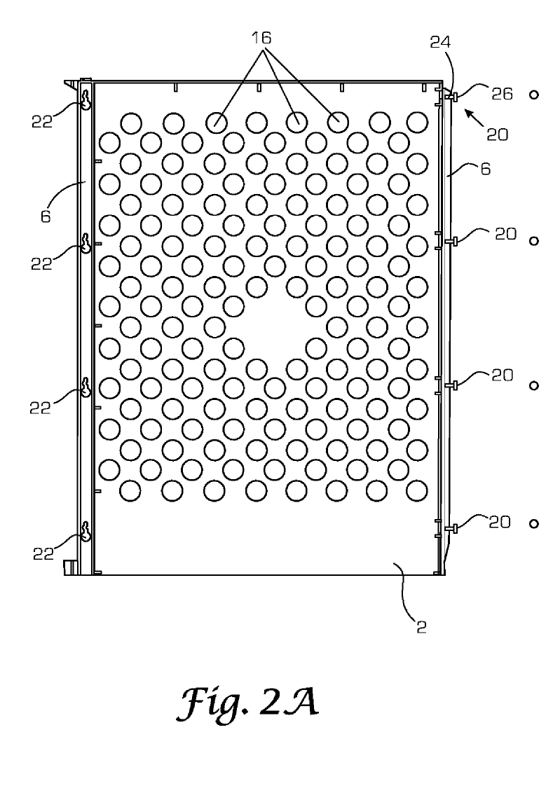

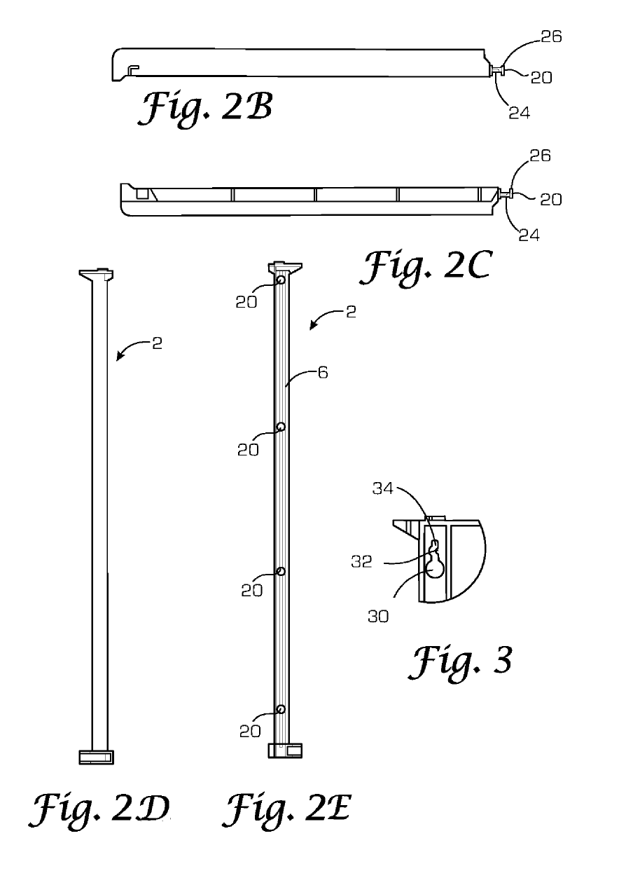

FIGS. 2A through 2E illustrate a first embodiment of the container system and the means therein for joining the vertical edges 6 of the modular panels 2 for construction of a planter 8. As shown, each vertical edge of each wall panel includes a connecting means. A first vertical edge includes a plurality of male connecting members 20 extending therefrom. The first vertical edge is illustrated in detail in FIG. 2A through 2C and FIG. 2E. A second vertical edge includes a plurality of female connecting members 22. The second vertical edge is illustrated in detail in FIG. 2A and FIG. 3.

The male connecting members 20 along the first vertical edge of the panel comprise a narrow post member 24 extending from the edge. The narrow post members terminate into a larger circular member 26, which represents the terminal end of the post member. The circular member on the terminal end of the post assists in retaining the post member in connection with the female connecting members 22.

The female connecting members 22 along the second vertical edge 6 of the panel 2 comprise an aperture having a circular portion 30 for receiving the terminal circular member 26 of a male connecting member 20. The aperture further includes a narrow slot 32 extending from the circular portion of the aperture. The narrow slot is sized for accommodating the narrow post member 24 of the male connecting member. However, the narrow slot is smaller than the terminal circular member of the male connecting member and prevents the separation of the male connecting member from the female connecting member once the post is inserted into the narrow slot. A bend 34 may be provided in the narrow slot to prevent the post from slipping from the retention position to the removal position where the circular portion of the aperture would align with the circular member of the post. Thus, the female connecting member will retain the post of the male connecting member in the narrow slot causing the edges of the panels to firmly adjoin one another upon proper connection.

In use a plurality of the male connecting members 20 are inserted into the female connecting members 22 by aligning and placing the terminal circular portion 26 of each male connecting member into the respective circular portion 30 of the aperture of the respective female connecting member. Then, the posts 24 slide manually upward into the narrow slots 32 of the female connecting members to lock the panels 2 into connection with one another. A series of panels are connected together and to form a rectangular shaped unit 8 as shown in FIG. 1 or into other configurations as desired and promoted by the availability of additional modular panels.

After assembly the series of panel members 2 may rest in a bottom panel member, which is not shown. The panels may be inserted into a long channel on the bottom panel member for retaining the vertical panels. Further, the bottom panel may include drain holes that promote proper moisture levels in the growing medium. Alternatively, the panels may rest in a water tray 14 as shown in FIG. 7.

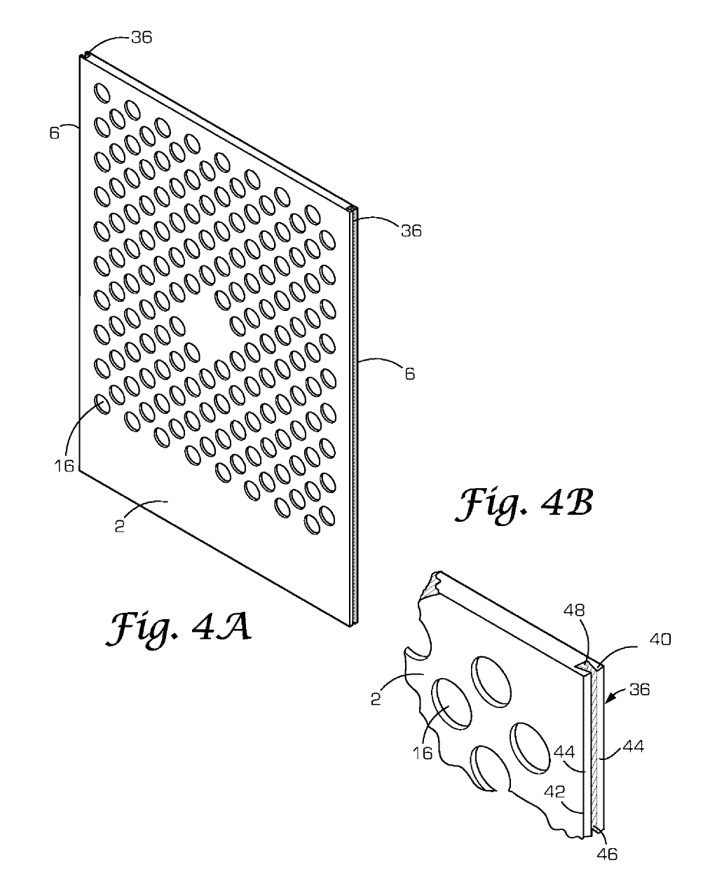

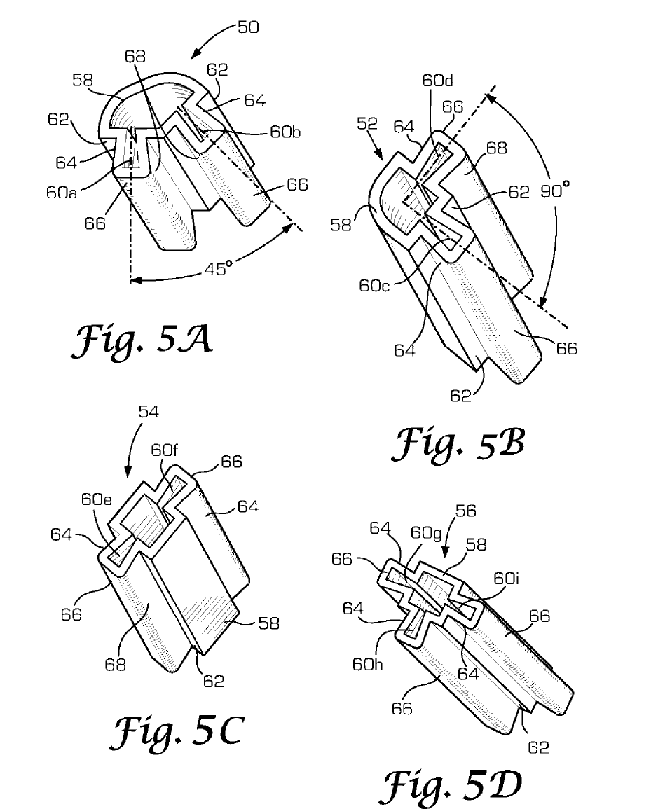

FIGS. 4 through 5 show another preferred embodiment of connecting means for joining adjacent vertical edges 6 of panels 2. The connecting means comprises separate suitably elongate female 36 and male 50, 52, 54, and 56 connector members of a length substantially equal to the lengths of the panel edges to be joined. FIGS. 4A and 4B illustrate a female connector member 36 in more detail. The female connector member comprises a channel or groove along each vertical edge of the panel members. The vertical edges of the panel members will be situated perpendicular to a horizontal ground surface when the panels are assembled into a planter box 8. The channel of each female connector member may run the entire length of the respective vertical edges or may comprise only a portion of the edge suitable for inserting the male connector member for joining a pair of panels.

The preferred female connector member or channel 36 is trapezoid shaped to fit the male connector member or rod 50-56 that is inserted therein when joining the panels 2. As shown, the preferred channel is formed by a pair of tabs 40 appending lengthwise from the edge 6 of the panel 2. The tabs define the opposing sidewalls of the channel. A first outer surface 42 of each tab faces outwardly from the channel and extends contiguously from the edge of the panel. The first outer surface 42 terminates into a perpendicular second outer surface 44 of each tab, which is parallel to the edge of the panel and forms the outer terminal end of the tab 40. The second outer surface 44 terminates and connects at an adjoining point from which an inner surface 46 of each tab begins facing inwardly on the channel. The inner surface of the tab runs inward to the edge of the panel at an acute angle a with respect to the second outer surface. The inner surface of each tab terminates at a point from which the edge of the panel runs to define a flat interior surface 48 of the channel between the tabs 40. The defined flat interior surface of the channel is physically presented by the edge 6 of the panel itself.

The acute angle a at which the inner surface 46 of each tab 40 connects to the edge 6 of the panel 2 defines the channel 36 such the interior surface 48 of the channel is longer than the distance between the tabs where the inner surfaces of the tabs connect to the second outer surfaces 44. Thus, the inner distance between the tabs is greater than the outer distances between the tabs, or rather; the inner portion of the channel is wider than the channel opening or mouth portion along the vertical panel edge. The narrower feature of the channel mouth provides for insertion of male connecting members 50-56 that will not slip out or readily disconnect by horizontally applied force, rather the male connecting member must be inserted or removed by sliding it out upwardly.

FIGS. 5A-5D illustrate the male connecting members or rods 50-56 used in association with the female connecting members or channels 36 shown in FIGS. 4A and 4B. The male connecting rod shown in FIG. 5A is a 45°-(degree) connecting member 50 useful in connecting panels 2 at a 45-degree angle. The male connecting rod shown in FIG. 5B is a 90°-connecting member 52 useful in connecting panels at a 90-degree angle. The male connecting rod in FIG. 5C is a 180°-connecting member 54 useful in connecting panels at a 180-degree angle. The male connecting rod in FIG. 5D is a combination 900 and 180° connecting member 56 useful in connecting two panels at an 180-degree angle and connecting a third panel at a 90-degree angle to the first two connected panels, such that the three connected panels form a T.

Each male connecting member 50-56 provides an elongate rod formed such that appending portions 60 of the rod insert into the female connecting members 36 on the respective panels 2. Each rod includes a central portion 58 that supports the connecting appendages 60. At least two appending portions extend from the central portion. The appending portions 60 comprise trapezoidal shaped members that fit and slide into the trapezoidal shaped channels of the female connecting members 36. In particular, each appending portion extends from a flat surface area of the central portion 58 of the rod. The flat surface of area of the central portion provides a lip area 62 about the originating location of the appending members. The lips 62 provide a guide for arrangement of the panels and connecting members. Further, the lips provide a surface for the tabs 40 of the female connecting members to rest against the male connecting rods.

A first edge 64 of each appending portion 60 extends outward from the central portion 58 at an angle a². A second edge 66 of each appending portion spaced apart from the first edge 64 of the appending portion extends outward at an angle a³. The first edge and second edge of the appending portions are not parallel. A third edge 68 of each appending portion 60 joins the ends of the first edge and second edge and runs parallel to the flat surface of the central portion 58 where the first edge and second edge originated. The third edge of the appending portion is longer than the distance separating the first edge and second edge where they originate on the central portion.

On the 45° connecting rod 50 shown in FIG. 5A, the appending portions 60a and 60b extend from flat surfaces of the central portion 58 of the rod. The flat surfaces of the central portion are angled apart to form an interior angle of 135-degrees between the planes of surfaces. Thereby, the appendages 60a and 60b extending perpendicular to the surfaces of the central portion 58 are situated at a 45-degree angle from one another from an imaginary centerline of the first appendage to an imaginary centerline of the second appendage.

On the 90° connecting rod 52 shown in FIG. 5B, the appending portions 60c and 60d extend from the flat surfaces of the central portion 58 of the rod. In this case, the flat surfaces are angled apart at an interior angle of 90-degrees between the planes of the surfaces. Thereby, the appendages 60c and 60d extending perpendicular to the surfaces of the central portion are situated at a 90-degree angle from one another from centerline of the first appendage to centerline of the second.

On the 180° connecting rod 54 shown in FIG. 5C, the appending portions 60e and 60f extend from flat surfaces of the central portion 58, in which the flat surfaces are situated in parallel spaced relationship to one another. Thereby, the appendages 60e and 60f extend perpendicular to the parallel surfaces of the central portion, and in opposing directions. These appendages from the central portion of the rod are situated at a 180-degree angle from one another from centerline of the first appendage to centerline of the second appendage. Thereby, the appendages 60e and 60f of the 180° connecting rod are aligned linearly as the centerline of each appendage falls along the same line.

On the combination 90° and 180° connecting rod 56 shown in FIG. 5D, three appending portions 60g, 60h and 60i form means for connecting three panels 2. Two appending portions 60g, 60h extend from flat surfaces of the central portion 58 that are situated in opposing parallel spaced relationship to one another. These first two appendages 60g, 60h are situated at a 180-degree angle from one another and are linearly aligned similar to the appendages of the 180° connecting rod. The third appending portion 60i extends from a flat surface of the central portion that is spaced apart 90-degrees from each of first two parallel surfaces on the central portion. Thereby, the third appending portion 60i extends from the central portion situated at a 90-degree angle from the remaining two appending portions.

The connecting members 36, 50-56 in FIGS. 4A-4B and 5A-5D permit the panels 2 to be connected in a variety of combinations using the 45, 90, and 180-degree connecting angles. The panels may be connected in a single triangular configuration using a combination of three panels 2 and three 450° connecting rods 50. The panels may be connected in a single square configuration using a combination of four panels and four 90° connecting rods 52. The panels may be connected in a rectangular configuration using at least six panels 2, four 90° connecting rods 52 and two 180° connecting rods 54.

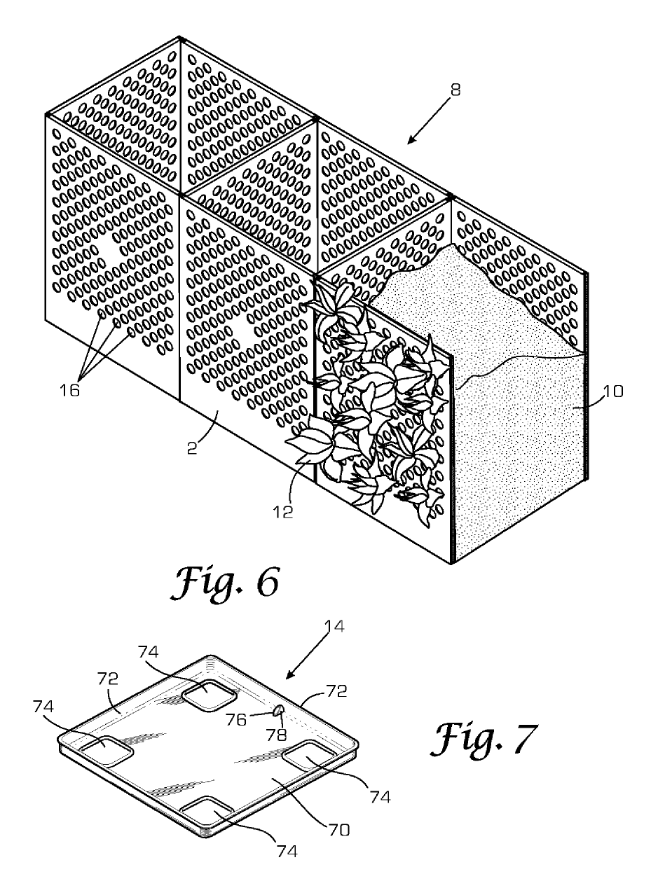

FIG. 6 illustrates an embodiment of the invention and a particular configuration that would use eight panels 2 on the exterior and two panels dividing the interior of the unit. Each exterior corner of the configuration in FIG. 6 would use a 90° connecting rod 52. Each union of two panels in linear alignment and a perpendicular interior-dividing panel would use a combination 90° and 180° connecting rod 56. Thus, the four connections including the linear panels and dividing panels would require a total of four combination connecting rods.

FIG. 7 illustrates a tray 14 for resting a square unit of four connected panels 2, such as in FIG. 1. The tray includes a substantially flat bottom planar member 70, that is substantially square and of slightly larger outer dimension that the outer dimension of the accompanying planter unit 8. Ridge members 72 extend upwards from the outer edges of the bottom planar member. The planter unit will rest within the inner area bounded by the ridge members. Thereby, the ridge members function to limit lateral movement of the planter and hold the planter in the tray. The ridge members may be continuous about the circumference of the tray to retain and direct the flow of fluids that come onto the tray from the planter.

The tray 14 may further include raised retaining surfaces 74. As shown, the raised retaining surfaces consist of four square-shaped surfaces raised upward from the surface area of the primary flat bottom planar member 70 of the tray. The square surfaces are oriented in each of the four corners of the bottom planar member and spaced apart equidistantly from the adjacent ridges 72 on the outer edges of the bottom planar member to form guides at each corner. The bottom edges of the connected panels 2 are aligned with the guides and placed within the guides to situate the planter unit 8 on the tray. The panel members may fit very tightly and securely in the guides on the tray, depending upon the selected tolerances for the spacing between the raised retaining surfaces 74 and ridge members 72.

The tray 14 shown in FIG. 7 includes a drain 76 that is formed of a aperture through a ridge member 72 along a selected edge. More apertures may be included as desired for specific drainage designs. The inventor has chosen a single drain 76 in which the aperture begins at a point level with the surface of the bottom planar member 70 so that any excess fluid can drain from the surface of the bottom planar member, versus water being retained on the surface of the bottom planar member. The aperture is bounded by a cylindrical pipe 78 for directing fluids through the ridge member 72 and out of the tray 14. Finally, the tray may include wheels, or may be placed on a cart.

An irrigation or water distribution system may be incorporated into the container 8 assembled by the system. An irrigation tube or pipe constructed of polyvinyl chloride may be inserted into the soil 10 contained with the container. Outlets spaced along the pipe would distribute water and nutrients evenly throughout the soil. Multiple pipes may be inserted into the soil in spaced relation in accordance with the size of the assembled container system. Further controls and sensors used in combination with the container system and water distribution system may interact with the unit to control distribution of water and other chemicals.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention as defined by the claims.

1. A container system comprising:
at least three panels each having a planar surface and two vertical edges;
a plurality of openings in the planar surface of the panels;
a female connecting member on the vertical edges;
at least three male connecting members that each adjoin to two or more female connecting members, whereby the panels are connected to form a modular planter with sides in which the plurality of openings in the panels are exposed along each side for growing plants.

2. A container system as in claim 1 in which the female connecting members each consist of an elongate channel and the male connecting members each consists of an elongate rod having a central portion and at least two appendages in which each appendage inserts into the elongate channel so as to join at least two panels together.

3. A container system as in claim 2 in which each elongate channel is trapezoid shaped and each appendage of the elongate rod is trapezoid shaped.

4. A container system as in claim 1 in which the modular planter formed by the panels is stacked vertically with at least one additional modular planter formed by the panels to increase the planting volume of the planter.

5. A container system as in claim 1 in which the modular planter formed by the panels includes one or more interior panels adjoined by the female connecting members and male connecting members to create one or more partitions within the modular planter.

6. A container system as in claim 1 in which the panels forming the modular planter rest on a top surface of a tray incorporating wheels on a bottom surface of the tray to form a cart.

7. A container system as in claim 6 in which the tray includes a substantially flat bottom planar member bounded by outer edges having slightly larger outer dimension than the modular planter, ridge members extend upwards from the outer edges continuous about the tray.

8. A container system as in claim 7 in which the tray includes raised retaining surfaces consisting of four square surfaces raised upward from the surface area of the bottom planar member, and each raised retaining surface is oriented in corners of the planar member and spaced apart equidistantly from the adjacent ridges members.

9. A container system as in claim 7 in which the tray includes an aperture in the outer edges for draining.

10. A container system as in claim 2 in which at least one of said elongate rods is a 90-degree connector having two appendages, and the appendages extend from a pair of surfaces of the central portion of the rod that are angled apart at an interior angle of 90-degrees between the surfaces, and the appendages extend perpendicular from the surfaces of the central portion and are situated at a 90-degree angle from one another from a centerline of the first appendage to a centerline of the second appendage.

11. A container system as in claim 2 in which at least one of said elongate rods is a 45-degree connector having two appendages, and the appendages extend from a pair of surfaces of the central portion of the rod that are angled apart at an interior angle of 135-degrees between the surfaces, and the appendages extend perpendicular from the surfaces of the central portion and are situated at a 45-degree angle from one another from a centerline of the first appendage to a centerline of the second appendage.

12. A container system as in claim 2 in which at least one of said elongate rods is a 180-degree connector having two appendages, and the appendages extend from a pair of surfaces of the central portion of the rod in parallel spaced relationship to one another, and the appendages extend perpendicular from the surfaces of the central portion in opposing directions and are situated at a 180-degree angle from one another from a centerline of the first appendage to a centerline of the second appendage.

13. A container system as in claim 2 in which at least one of said elongate rods is a combination 90/180-degree connector having first, second and third appendages;
the first appendage and the second appendage extend from a pair of surfaces of the central portion of the rod that are in parallel spaced relationship to one another, and these two appendages extend perpendicular from the surfaces in opposing directions and are situated at a 180-degree angles from one another from a centerline of the first appendage to a centerline of the second appendage;
the third appendage extend from a surface of the central portion that is spaced apart 90-degrees from each of the pair of surfaces in parallel spaced relationship, and the third appendage extends from the central portion situated at a 90 degree angle with respect to the first and second appendages.

14. A container system as in claim 2 having at least four panels and at least four elongate connecting rods.

15. A container system as in claim 2 having at least eight panels and at least six elongate connecting rods.
